(19) United States
(12) Patent Application Publication
(10) Pub. No.: US 2024/0117612 A1
(43) Pub. Date: Apr. 11, 2024

(54) Novel Method of Continuous Fluids Flow Mapping and Characterization in Plumbing Systems/Networks

(71) Applicants: Markus Johannes Lenger, Capistrano Beach, CA (US); Gary Arthur Klein, Rancho Cordova, CA (US)

(72) Inventors: Markus Johannes Lenger, Capistrano Beach, CA (US); Gary Arthur Klein, Rancho Cordova, CA (US)

(21) Appl. No.: 17/961,518

(22) Filed: Oct. 6, 2022

(51) Int. Cl. E03B 7/07; G06F 30/18; G06F 30/20

(52) U.S. Cl. CPC E03B 7/071; E03B 7/078; G06F 30/18; G06F 30/20; G06F 2113/14

(57) ABSTRACT

A mapping and flow monitoring system allowing real time flow monitoring in a plumbing network. The mapping and flow monitoring system is comprised of (i) a network of at least two pressure sensors and, to analyze and understand the plumbing network with greater resolution and accuracy, additional pressure sensors and/or networked sensors for other water parameters including but not limited to flow rate, temperature, vibration and water quality, (ii) data acquisition and management hardware and software, (iii) data analyses (both edge/distributed computing and centralized computing), and (iv) plumbing network interpretation and diagnostics. Uses of the mapping and flow monitoring system include but are not limited to mapping extant plumbing networks, usage monitoring, development of a knowledge base for improved selection of plumbing network components, automated controls operation, anomaly detection, and identifying unique plumbing network characteristics.

In its most basic configuration, two (2) or more high-resolution (both temporal resolution and sensitivity) pressure sensors are deployed to infer flow rate and to identify fixtures in use in a plumbing network. Simultaneously analyzing the pressure signatures from more than one pressure sensor enables the more accurate determination of which control device is being used within a plumbing network. The addition of other sensors allows further data refinement for more accurate and granular flow estimations.

### CROSS-REFERENCE TO RELATED APPLICATIONS

This application claims the benefit of provisional patent application Ser. No. 63/252,905 filed 2021 Oct. 6 by the present inventors.

### FEDERALLY SPONSORED RESEARCH

Not Applicable

### SEQUENCE LISTING OR PROGRAM

Not Applicable

### BACKGROUND—FIELD OF INVENTION

This invention relates to continuous flow monitoring in plumbing systems/networks allowing precise mapping of plumbing systems, usage monitoring, development of a knowledge base for improved selection of plumbing system components and automated controls operation.

Applicants have invented a plumbing system/network mapping and flow monitoring system that may be used to continuously monitor flow through a plumbing system/network with higher resolution and accuracy and with lower cost than prior flow measurement systems. The system is comprised of a heterogeneous network of real time sensors, data management hardware and software, data analyses (both edge/distributed computing and centralized computing) and plumbing system interpretation and diagnostics. Data analyses (conducted based on signals from individual sensors and based on aggregating data from multiple sensors and potentially of different sensor types) include but are not limited to pattern recognition, network analysis, event detection, trend analysis, artificial neural network analyses and other machine learning techniques. Uses of outputs from the system include but are not limited to mapping extant plumbing systems/networks, usage monitoring, development of a knowledge base for improved selection of plumbing system/network components, and design and automated controls operation. The details of the system have neither been published, shown to the public nor sold as of this filling.

### BACKGROUND OF THE INVENTION

In applicants most basic configuration, two (2) or more high-resolution (both temporal resolution and sensitivity) pressure sensors are deployed to infer flow rate and which control device(s) (see definition) is in use in a plumbing system/network. Simultaneously analyzing the pressure signatures from more than one pressure sensor enables more accurate determination of which control device is being used within a plumbing system/network. Control devices generate pressure waves/signatures on both opening and closing. Simultaneously analyzing signatures from a heterogeneous network of sensors (a network of sensors monitoring different parameters impacted by flow) would further improve the accuracy and granularity of determinations over a sensor array of only pressure sensors. The system described in this patent application is a significant innovation compared to flow measurement and mapping systems currently in use or patented because it is the first system that leverages plumbing system/network characteristics and a network of sensors for more accurate and granular flow estimations. The current state of the art in flow mapping entails either measurement at a single point in a plumbing system/network or submetering with flow meters at a limited number of locations along a network and without network analysis of outputs of the submeters.

Control devices in plumbing systems/networks, when activated either manually or electromechanically, produce a distinct pressure signature. This unique pressure signature can be used to help identify a specific control device. Applicant's research has found that recognizing the unique pressure signature generated by a particular control device presents a challenge in larger plumbing systems/networks: the pressure signature either gets distorted, more than one control device creates pressure signatures that are similar, or multiple pressure events occur simultaneously, thus making identification of specific plumbing fixtures unreliable. Furthermore, existing solutions require training of the software to recognize a fixture by providing multiple use events to create a comparative ‘fingerprint’. Applicants' invention uses a minimum of two (2) high-resolution pressure sensors preferably located at or toward the end of a plumbing system/network branch. Pressure sensors can be installed wherever is most convenient. However, accuracy will increase significantly the further they are from the intersection of the X, Y and Z axes or greatest distances in the plumbing network. This multi-pressure sensor array allows the comparison of all pressure signatures for the same pressure event in the plumbing system/network topology to be monitored, analyzed, and controlled. Not only do multi-pressure sensor arrays allow for identification of multiple simultaneous pressure events, such as control device activation, it also allows for the precise location of any activated control device using the time delays in receiving the same pressure signatures. Time of Flight calculations will provide a basis to precisely determine the locations of control devices in the plumbing system/network. All data are measured, combined, and analyzed in real time to visualize flow conditions in a plumbing system/network providing control and optimization of fluid usage, flow anomalies, sub metering, and energy efficiency.

Furthermore, the installation of said pressure sensors can be achieved without ‘shutting down, depressurizing, cutting into, repressurizing and restarting’ the existing plumbing system, allowing faster and far less expensive installation without the liability concerns that would arise due to altering the existing plumbing system/network (that might require re-permitting, commissioning, inspecting, or testing).

Definitions: We define the following terms for clarification:

Fluids: liquids or gases or mixtures thereof.

Plumbing System/Network: fluid distribution networks in buildings, chemical, biological or industrial systems, refineries, agriculture, and public and private water distribution systems.

Sensor Network: Two or more sensors deployed at key locations within a plumbing network. The sensors array may be homogeneous (all pressure sensors) or heterogeneous (a combination of pressure sensors and sensors of other types such as, but not limited to, flow meters, temperature sensors, vibration sensors and water quality sensors). Sensors transmit data either by means of hard wiring or via wireless transmission.

Distribution Flow Paths: Flow in pipe mains, trunks, branches, risers, fixture supply, fixture branches, storage devices, regulating devices, plumbing appliances, plumbing appurtenance, and return loops.

Axis: Direction or vector of network layout. For ease of explanation the axis/vectors are names X, Y, Z and so forth. This is merely an aid to understanding a plumbing network but does not necessarily mean the Cartesian system is implied. It merely shows the direction of the plumbing piping and or the direction of the distribution flow path.

Flow Mapping: a computational method, with or without the use of visualization, that assigns a flow in the system to individual branches, loops, fixtures appurtenances and other components, enabling the understanding, analysis, and control of a plumbing network of any size or configuration.

Time of Flight (TOF): TOF is the time it takes a wave, object, or particle to travel a given distance.

Control Devices: any plumbing system device capable of modifying the flow of fluids such as but not limited to plumbing fixture fittings, appliances, valves, check valves, back flow preventers, flow regulators, and pumps.

Trigger Event: Deviation of baseline pressure from moving average triggering an analysis event.

Usage Event: opening or closing of a control device.

Considerations of Flow Mapping in Plumbing Systems

For ease of discussion, we will describe how applicants' invention works in water-based plumbing systems/networks, like those found in buildings. The principles and methods discussed below work on all plumbing systems or plumbing networks.

Flow mapping—detailed quantification or estimation of the discharge through distribution mains, branches, recirculation loops, fixtures, control devices and appurtenances of a plumbing system/network—can be a vital tool in understanding the water utilization and conservation, energy utilization and potential for water quality degradation in a plumbing system/network. In current practice, flow mapping relies on decades-old data and analytical tools such as the ‘Hunter Curve’ that were developed based on plumbing systems/networks and usage patterns no longer characteristic of current day systems. These methods have come under scrutiny as building science has advanced and some of the old paradigms and understandings have been challenged and questioned. Measurements and studies by the applicants have already proven that in general, plumbing pipe diameters are larger than necessary. These larger diameters increase construction and operating costs and decrease water quality.

To update these methodologies and allow correct plumbing system/network sizing and understanding of present plumbing practices, precise and detailed data are needed that reflect modern plumbing system/network design and utilization. Specifically, collecting and analyzing data on the actual performance of existing plumbing systems/networks enables the design and installation of more appropriately sized piping networks. Applicants' invention allows for the precise and detailed collection of such data to understand and, if desired, optimize and control the dynamics of a plumbing system/network. Furthermore, it allows for the precise location of flow anomalies such as leaks and water hammers. Rapid identification of flow anomalies can reduce damage caused by the fluids, substantially decrease the plumbing system/network troubleshooting time, and therefore repair costs. It is therefore desirable to map out precise flow characteristics in a plumbing system/network. Finally, precise and detailed flow information may be used to assess system design, usage and performance for promoting water and energy conservation and as a component of a water management program.

Pressure Signature Sensing and Analysis

Although pressure sensing is not new in arts, existing methods rely on single-point pressure measurements and require extensive training for the system to recognize individual fixtures.

Applicants' invention uses the pressure signatures (high-resolution time series of pressure data) and outputs from a real time sensor network to assign flow to controls within a plumbing system/network as a trigger to start Time of Flight calculations along each axis for the precise calculation of location in multiple dimensions. This drastically increases the accuracy of the methodology. If more than one fluid, or the same fluid at different temperatures need to be analyzed separately, a set of pressure sensors needs to be deployed on each plumbing system/network to be measured. Furthermore, it uses pressure signatures to characterize fixture activity throughout the plumbing system/network that is being monitored. Time of Flight analysis can also be used to calculate approximate flow rates within a plumbing system/network in addition to measuring wave traverse time for pressure events and water traverse times for temperature events. As any distortions happen to both measurements similarly a consistent correlation can be established. This allows a precise real-time characterization of flows and events in a plumbing system/network. The pressure sensor system described here can be used in combination with flow metering at strategic locations and a network of strategically placed other sensors to generate even more precise and granular flow data.

Other Sensors and Meters

Deployment of other sensors and analysis of their outputs along with analysis of pressure data can improve both the precision of flow mapping (i.e., improve the likelihood that flows are assigned to the correct control/fixture) and the granularity of flow mapping (i.e., increasing the resolution of assignments such that flows may be correctly assigned to individual fixtures/controls rather than to a branch or plumbing system/network component with multiple controls).

Flow Meters

The applicants' invention combines the pressure signatures and the associated time delays with flow rates to enhance and improve the understanding of plumbing systems/networks. As an example of this, water utilities measure the water they sell to consumers, often using a measurement method called ‘positive displacement’ creating a magnetic pulse to count water usage. This pulse can also be externally detected via a magnetic sensor known as a Hall-effect sensor. Several devices on the market such as ‘The Flume’ deploy this methodology and is common in the arts. When convenient and having enough accuracy, applicants' invention can deploy the use of a Hall-effect sensor to pick up flow measurement pulses from the utility water meter. Alternatively, the applicants' invention may utilize an additional flow meter installed in (or on) the central feed line or at other strategic locations such as on major branches after the utility's water rate meter. To measure cold and hot fluid flows individually, flow meters need to be installed in (or on) each flow path. Applicant's approach is of a passive nature, using methods that require no modification of existing plumbing systems with the purpose of enhancing time-of-flight calculations.

Temperature Sensing

Temperature sensors located at the beginning of the plumbing system/network and at key locations in the piping network, including close to the pressure sensing and flow measurement locations, help refine the determination of which control devices have been activated, are being used or have been turned off. The applicants' invention combines the pressure signatures and the associated temperature data to enhance and improve the understanding of plumbing systems/networks. If the pipe diameter and length are known, the flow rate can be estimated by analyzing the rate of change of temperature. This information combined with applicants above mentioned pressure signature analysis will allow calculation of the flow rate in the plumbing system/network without the use of a flow meter.

Accelerometers

Accelerometers may be deployed to sense vibrational events and their force and direction to reduce false positives and produce additional useful data points.

### DETAILED DESCRIPTION OF THE METHOD

The following steps detail the method:

1. Pressure Signature Sensing

A high-resolution pressure sensor is deployed at key locations of the plumbing system/network. Ideally, sensors are deployed at the ends of branches and near controls/fixtures via connections upstream of fixtures; those connections can be made without cutting pipe via insertion of tee connectors or other fittings. It is important that the pressure sensor range extends from zero to higher than the maximum plumbing system/network pressure so that high-pressure spikes are detected. The pressure readings are sampled at appropriate intervals, typically multiple times per second. Since pressure waves are propagating through a fluid and wave speed is influenced by fluid speed, both control devices, usage and velocity of the fluid may be deduced from aggregated and analyzed data from multiple pressure sensors deployed in the plumbing system/network.

2. Sensor Network (or Sensor Array)

Pressure sensors are ideally installed on each branch of a plumbing system/network and as far as possible (in terms of pipe/network length) from each other. An easily accessible control device near the terminus of an axis or branch is an ideal location to install the sensor by adding a T-connector containing the sensor to the control device, such as shutoff valves found at installed fixtures. Where applicable, the pressure sensors can be installed on only two branches; the pipe/network distance between the sensors creates a distinct and reliable pressure signature that may be used to deduce both fixture in use and fluid velocity.

3. Flow Determination

The use of flow meters improves the understanding of the flow mapping provided by the applicant's invention. While optional, flow meters increase accuracy and reduce misclassification in certain circumstances. Flow measurements can be achieved using a variety of flow sensors, but a clamp-on ultrasound or Doppler shift system is preferred, as they do not require ‘cutting into’ the existing plumbing system. To capture the entire flow into the building or structure such flow meters should be mounted (clamped on) after the main water meter and before the first branch. Alternatively, the magnetic pulse from a water rate meter can be detected using a Hall-effect sensor to calculate the flow rate. Separate flow meters need to be installed on each fluid type to be analyzed. Although applicants' invention does not require a flow meter to function properly the optional addition of a flow meter or flow meter data from an already installed flow metering device will create a flow reference that will increase accuracy and enhance the plumbing system/network analysis.

4. Use Event Capture and Fixture Identification

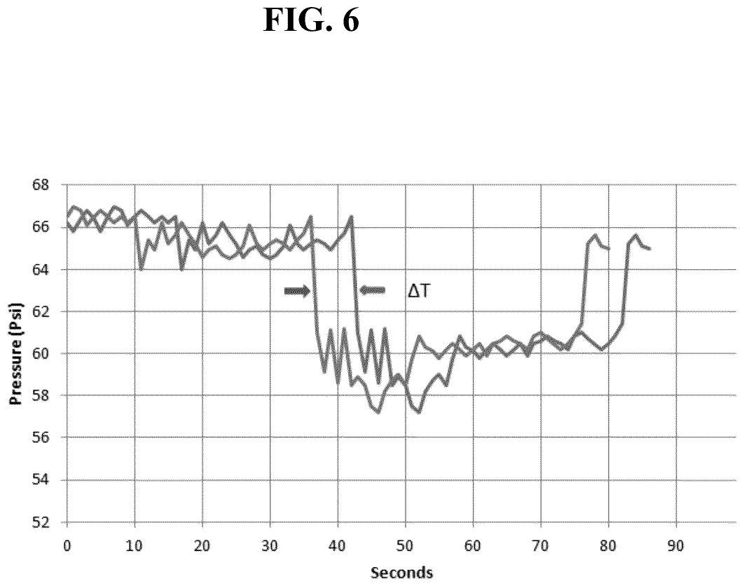

Pressure measurements are sampled at a predetermined frequency at each sensor. A sliding acquisition window is used for waveform analysis and processing. Typical waveforms (FIG. 6) are captured in the sampling window time by each sensor in the system. Each waveform is processed using signal processing methods:
Culling and Despiking. Outlying and non-representative data are removed
Smoothing. The waveform is smoothed using averaging and filtering techniques
Flow Mapping. Time of Flight calculations and output come from pattern recognition (pressure signature recognition and output from non-pressure sensors) and are used along with information on plumbing network design to map flow to the fixtures/controls that are in use, their use duration and the flow through all connected plumbing (main distribution, branches, risers and connections to flowing fixtures).
Edge Detection. Discernible transitions are identified that triggers the following two analysis:
1. Pattern Recognition. Data are mined using a variety of techniques (empirical, analytical and machine learning/AI) to identify typical pressure signature curves. Data mining is conducted using data from all sensors deployed in the network and using network topology data along with information on sensor locations within the network
2. Use Event Isolation. A use event is a single use of a fixture/control. Use event signals are bookended by pressure waves generated via the opening and closing of valves or other fittings that operate controls. Other sensors such as flow meters and temperature sensors also produce data that signal a period of use. The time of the trigger event is determined for each sensor's waveform starting the Time of Flight calculation.

Additional passive sensing (pressure, flow, temperature, acceleration), and detailed analysis of the data (both pressure and other) can be employed to establish reference events, and to further characterize the specific topological components (elbows, impingements, collars, etc.).

5. Flow Monitoring

Adding to the above-mentioned dynamic flow computations, the flow rate data allow calculation of the accurate flow rate of each use event, even during multiple simultaneously engaged control devices. This allows one to build a precise real time flow map of a plumbing system/network allowing identification of any inefficiencies and to optimize fluid usage and increase energy efficiency. Plumbing system/network design and construction errors can be easily identified and corrected as the precise nature of an anomaly or inefficiency is detected and analyzed.

6. Leak Detection

While the main purpose of this invention is to get a real-time multi-dimensional flow modeling to increase fluid utilization efficiency and where applicable energy efficiency, the modeling does allow one to detect and visualize plumbing anomalies such as leaks, water hammers and blocked pipes. Since the applicants' invention narrows the search parameters, this reduces the unnecessary ‘opening up’ of walls and therefore reduces repair costs.

### PRIOR ART

U.S. patent Ser. No. 10/962,439 Enev et al “Water leak detection using pressure sensing” describes a method using only a single pressure sensor for leak detection. While pressure signatures are discussed to identify fixtures, it fails to allow any locating/mapping of the fixture without prior mapping and then only for leak detection. Multiple sensors and axes as well as flow modeling are not discussed. Applicants believe their invention has distinct advantages over Enev et al. Furthermore, applicants' invention allows real time mapping using multiple sensors and Time of Flight calculation methodologies.

U.S. Ser. No. 10/663,933B2 Rakesh et al. “Systems and Methods for Subnetwork Hydraulic Modeling” describes a method for distributed flow and pressure monitoring to develop data for improving resolution of hydraulic models of municipal drinking water distribution systems. While this method, like the applicants', entails aggregation of distributed measurements for generating information about a fluids network, it aggregates the data directly as flow data and without signal interpretation, does not imply use of multiple sensors for improving the accuracy of flow determinations and addresses the hydraulics of continually flowing systems (as compared with plumbing systems that are subject to stagnation periods, irregular demands, frequent operation of controls and other phenomena not typical of municipal distribution systems).

Vadwa et al. Patent WO2022132588A1, “Determining alternative outcome or event based on aggregated data” uses successive signals from a sensor in a distribution network to detect and confirm events and anomalies in the distribution network. This method differs significantly from the applicants' because it is intended purely as a means for event or anomaly detection as well as relying on interpretation of data from only a single sensor at a fixed location in a distribution network and because does not use the full range of analysis tools in the applicants' method.

### DRAWINGS

Applicant has included one drawing sheet explaining the methodology of continuous fluids flow mapping.

### DRAWING LEGENDS

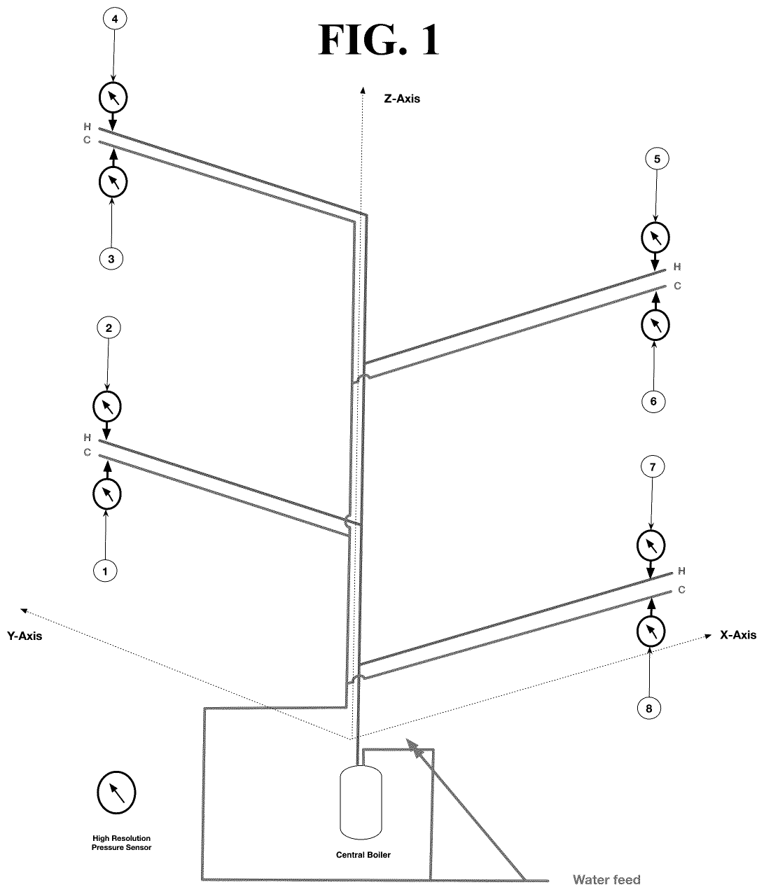

FIG. 1
1. High Resolution Pressure Sensor Branch 1 Cold Water
2. High Resolution Pressure Sensor Branch 1 Hot Water
3. High Resolution Pressure Sensor Branch 2 Cold Water
4. High Resolution Pressure Sensor Branch 2 Hot Water
5. High Resolution Pressure Sensor Branch 3 Hot Water
6. High Resolution Pressure Sensor Branch 3 Cold Water
7 High Resolution Pressure Sensor Branch 4 Hot Water
8. High Resolution Pressure Sensor Branch 4 Cold Water

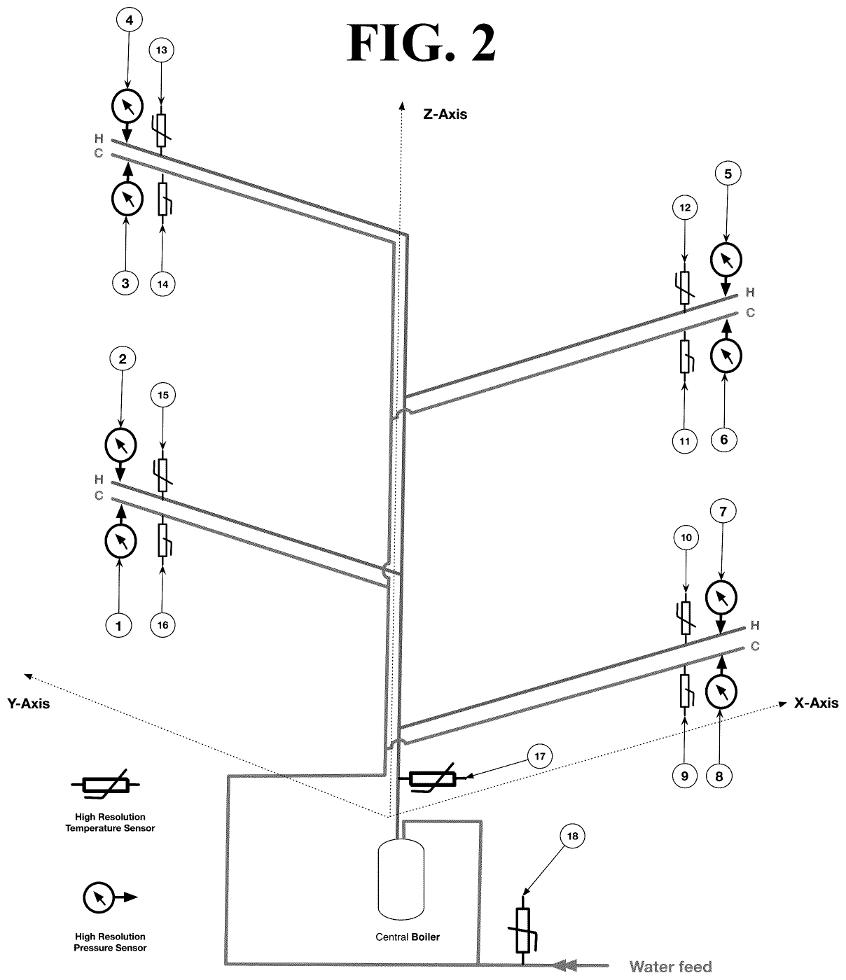

FIG. 2
1. High Resolution Pressure Sensor Branch 1 Cold Water
2. High Resolution Pressure Sensor Branch 1 Hot Water
3. High Resolution Pressure Sensor Branch 2 Cold Water
4. High Resolution Pressure Sensor Branch 2 Hot Water
5. High Resolution Pressure Sensor Branch 3 Hot Water
6. High Resolution Pressure Sensor Branch 3 Cold Water
7 High Resolution Pressure Sensor Branch 4 Hot Water
8. High Resolution Pressure Sensor Branch 4 Cold Water
9. High Resolution Temperature Sensor Branch 4 Cold Water
10. High Resolution Temperature Sensor Branch 4 Hot Water
11. High Resolution Temperature Sensor Branch 3 Cold Water
12. High Resolution Temperature Sensor Branch 3 Hot Water
13. High Resolution Temperature Sensor Branch 2 Hot Water
14. High Resolution Temperature Sensor Branch 2 Cold Water
15. High Resolution Temperature Sensor Branch 1 Hot Water
16. High Resolution Temperature Sensor Branch 1 Cold Water

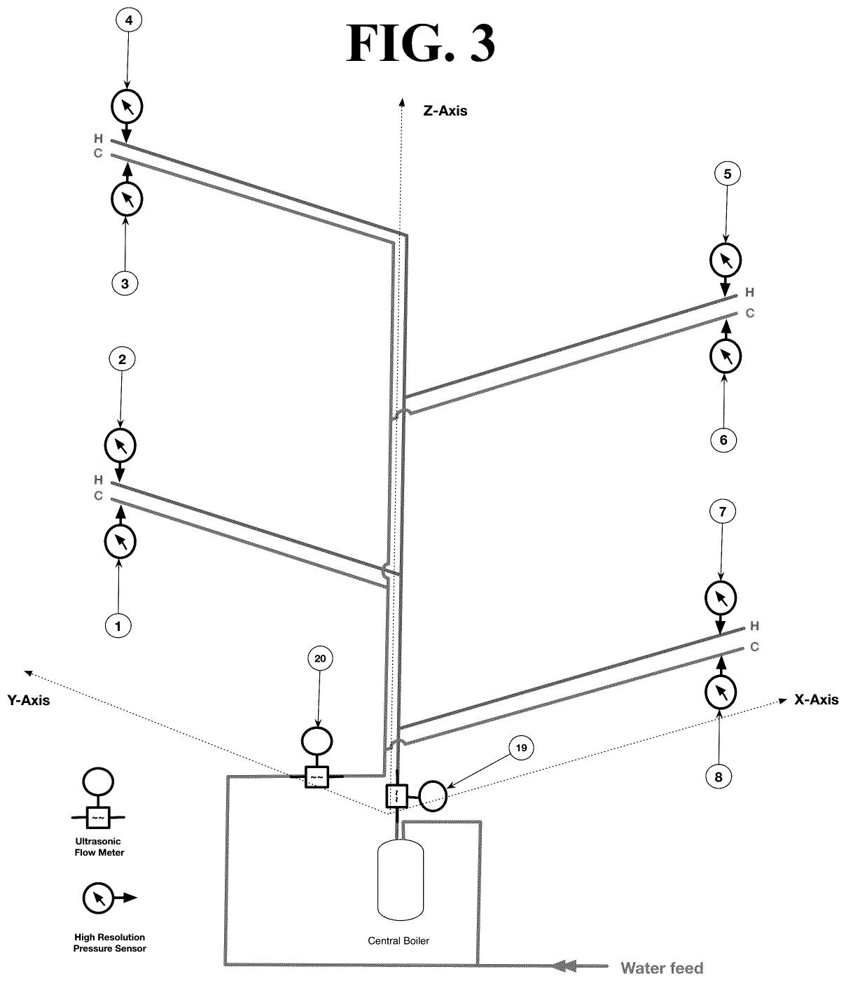

FIG. 3
1. High Resolution Pressure Sensor Branch 1 Cold Water
2. High Resolution Pressure Sensor Branch 1 Hot Water
3. High Resolution Pressure Sensor Branch 2 Cold Water
4. High Resolution Pressure Sensor Branch 2 Hot Water
5. High Resolution Pressure Sensor Branch 3 Hot Water
6. High Resolution Pressure Sensor Branch 3 Cold Water
7 High Resolution Pressure Sensor Branch 4 Hot Water
8. High Resolution Pressure Sensor Branch 4 Cold Water
9. Ultrasonic or Doppler Clamp-On Flow meter for Hot Water
10. Ultrasonic or Doppler Clamp-On Flow meter for Cold Water

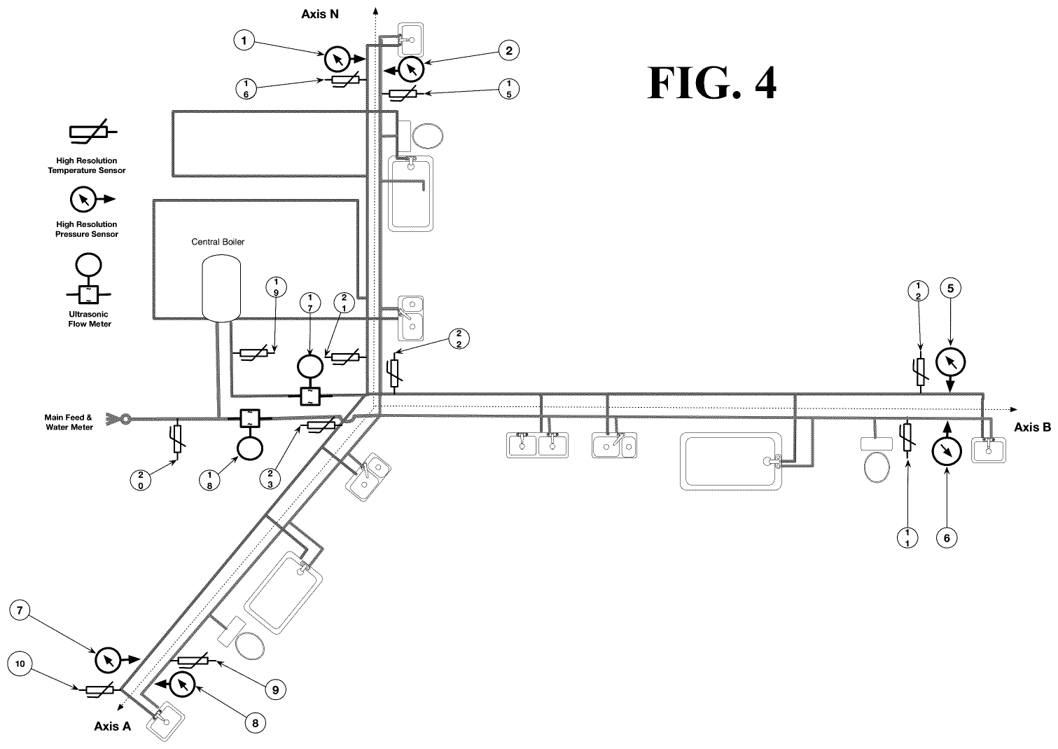

FIG. 4
1. High Resolution Pressure Sensor Axis N Hot Water
2. High Resolution Pressure Sensor Axis N Cold Water
3. Not used on this drawing—Refer to FIGS. 1 and 2
4. Not used on this drawing—Refer to FIGS. 1 and 2
5. High Resolution Pressure Sensor Axis B Hot Water
6. High Resolution Pressure Sensor Axis B Cold Water
7. High Resolution Pressure Sensor Axis A Hot Water
8. High Resolution Pressure Sensor Axis A Cold Water
9. High Resolution Temperature Sensor Axis A Cold Water
10. High Resolution Temperature Sensor Axis A Hot Water
11. High Resolution Temperature Sensor Axis B Cold Water
12. High Resolution Temperature Sensor Axis B Hot Water
13. Not used on this drawing—Refer to FIG. 2
14. Not used on this drawing—Refer to FIG. 2
15. High Resolution Temperature Sensor Axis N Cold Water
16. High Resolution Temperature Sensor Axis N Hot Water
17. Ultrasonic or Doppler Clamp-On Flow meter for Hot Water Total
18. Ultrasonic or Doppler Clamp-On Flow meter for Cold Water Total
19. High Resolution Temperature Sensor Hot Water Total
20. High Resolution Temperature Sensor Cold Water Total

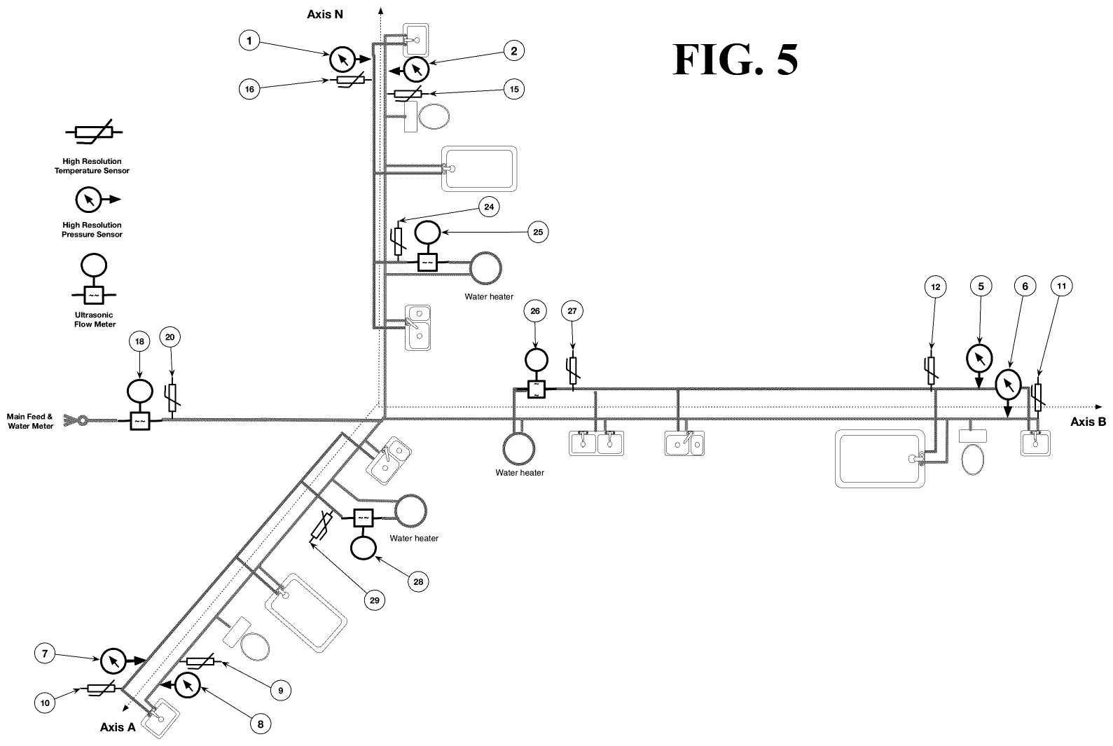

FIG. 5
1. High Resolution Pressure Sensor Axis N Hot Water
2. High Resolution Pressure Sensor Axis N Cold Water
3. Not used on this drawing—Refer to FIGS. 1 and 2
4. Not used on this drawing—Refer to FIGS. 1 and 2
5. High Resolution Pressure Sensor Axis B Hot Water
6. High Resolution Pressure Sensor Axis B Cold Water
7 High Resolution Pressure Sensor Axis A Hot Water
8. High Resolution Pressure Sensor Axis A Cold Water
9. High Resolution Temperature Sensor Axis A Cold Water
10. High Resolution Temperature Sensor Axis A Hot Water
11. High Resolution Temperature Sensor Axis B Cold Water
12. High Resolution Temperature Sensor Axis B Hot Water
13. Not used on this drawing—Refer to FIG. 2
14. Not used on this drawing—Refer to FIG. 2
15. High Resolution Temperature Sensor Axis N Cold Water
16. High Resolution Temperature Sensor Axis N Hot Water
17. Not used on this drawing—Refer to FIG. 4
18. Ultrasonic or Doppler Clamp-On Flow meter for Cold Water Total
19. Not used on this drawing—Refer to FIG. 4
20. High Resolution Temperature Sensor Cold Water Total
21. Not used on this drawing—Refer to FIG. 4
22. Not used on this drawing—Refer to FIG. 4
23. Not used on this drawing—Refer to FIG. 4
24. High Resolution Temperature Sensor Axis N Hot Water Heater Output
25. Ultrasonic or Doppler Clamp-On Flow meter Axis N for Hot Water Heater Output
26. Ultrasonic or Doppler Clamp-On Flow meter Axis B for Hot Water Heater Output
27. High Resolution Temperature Sensor Axis B Hot Water Heater Output
28. Ultrasonic or Doppler Clamp-On Flow meter Axis A for Hot Water Heater Output
29. High Resolution Temperature Sensor Axis A for Hot Water Heater Output

FIG. 6.

Example graph of Sensor outputs and Time-of-flight (Δt)

### CONCLUSION

Applicants have invented a novel method to measure, map, analyze and visualize flow and flow events in fluid plumbing systems/networks. The simultaneous analysis of pressure signatures and their time differences using Time of Flight calculations enables a comprehensive real time topological mapping of flow and flow events in fluid systems. The passive nature of the method requires no invasive modification to fluid systems and achieves superior accuracy while eliminating virtually all false positives and minimizing interference. Applicants believe their invention can be deployed at significantly lower cost achieving far superior accuracy than other flow mapping systems.

What is claimed is:

1. A method of mapping utilization/demand and analyzing a plumbing system or plumbing network comprised of a network array of real time sensors, feeding data from said real time sensors into a data management hardware configuration, using said hardware configuration to output data to software for data analyses (both edge/distributed computing and centralized computing) and using said software to map flows onto the plumbing system/network or to map the plumbing system/network itself.

2. The method of claim 1, wherein said real time sensors are a network array of two or more pressure sensors deployed in key locations in the plumbing system/network or of pressure sensors deployed in combination with sensors/meters of other parameters including but not limited to flow, temperature, vibration, and water quality.

3. The method of claim 1, said real time sensors are arranged in a plumbing system/network to optimize their value of information and maximize the granularity of assignment of flow to plumbing system/network components (branches, fixture fittings, appurtenances, etc.).

4. The method of claim 1, said real time sensors are either physically or wirelessly connected to data management hardware using either edge/distributed computing or centralized computing or a combination thereof.

5. The method of claim 4, wherein said data management hardware runs a data analysis software examining the multiple pressure signatures to determine plumbing fixture types.

6. The method of claim 5, wherein said data management hardware runs a data analysis software and calculates the time of flight (TOF) of multiple pressure signatures to determine the specific location of the plumbing fixture event.

7. The method of claim 5, wherein said data management hardware runs a data analysis software examining outputs from sensors other than pressure sensors to increase the precision of flow mapping.

8. The method of claim 5, wherein said data management hardware runs data analysis software combining all data collected from said real time sensors to determine all plumbing system/network control devices located within said plumbing system/network.

9. The method of claim 5 where all collected data are time stamped and stored either locally, on a network attached storage (NAS), or in the cloud.

10. The method of claim 8, wherein a visualization software maps out the plumbing system/network in real time to allow observation and study of plumbing system/network interactions and flow characteristics in the distribution flow paths.

11. The method of claim 10, wherein the plumbing system map is combined with events logged as described in claims 6 and 7 allowing detection of flow not triggered by an event or unusual flow, that is flagged as a possible leak or plumbing system/network failure.

12. The method of claim 10, wherein interactions and flow characteristics are used to modify the existing plumbing system design as well as identifying future design advantages.
